(19) United States
(12) Patent Application Publication
(10) Pub. No.: US 2008/0130929 A1
(43) Pub. Date: Jun. 5, 2008

(54) Hearing device with interference sound suppression and corresponding method

(75) Inventors: Georg-Erwin Arndt, Obermichelbach (DE); Frank Koch, Erlangen (DE); Thomas Lotter, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/998,376

(22) Filed: Nov. 29, 2007

(30) Foreign Application Priority Data
Dec. 1, 2006 (EP) 06024958.8

(51) Int. Cl. H04R 25/00

(52) U.S. Cl. 381/328

(57) ABSTRACT

The aim is to better suppress background noises during the use of hearing devices. To this end, provision is made to record an electrical or electromagnetic useful signal via a corresponding interface and an interference sound by means of a microphone of the hearing device. The processed useful signal is output from a receiver of the hearing device. A vent is formed when the hearing device is worn in or on the ear, through which vent a sound transmission function from the microphone to the eardrum of the hearing device wearer exists. The interference sound signal of the microphone is filtered as a function of the sound transmission function of the vent such that an interference sound reaching the eardrum through the vent is reduced in its effect on the eardrum by means of a balancing sound, which is generated on the basis of an interference sound signal of the microphone from the receiver. The sound reaching the eardrum through a vent can thus be reduced in its interference effect by means of out-of-phase cancellation.

### CROSS REFERENCE TO RELATED APPLICATIONS

This application claims priority of European Patent Office application No. 06024958.8 EP filed Dec. 1, 2006, which is incorporated by reference herein in its entirety.

### FIELD OF INVENTION

The present invention relates to a hearing device with a useful signal interface for recording an electrical or electromagnetic useful signal, a microphone for recording an interference signal and a receiver for outputting a processed useful signal, with a vent being formed while the hearing device is being worn in or on the ear, through which vent a sound transmission function exists from the microphone to the eardrum of the hearing device wearer. The present invention also relates to a corresponding method for reducing an interference sound while the hearing device is being worn.

### BACKGROUND OF INVENTION

Hearing devices are wearable hearing apparatuses used to assist the hard-of-hearing. To meet the numerous individual requirements, different designs of hearing device are provided, such as behind-the ear (BTE) hearing devices, in-the-ear (ITE) hearing devices and concha hearing devices. The typical configurations of hearing device are worn on the outer ear or in the auditory canal. Above and beyond these designs however there are also bone conduction hearing aids, implantable or vibro-tactile hearing aids available on the market. In such hearing aids the damaged hearing is stimulated either mechanically or electrically.

Hearing devices principally have as their main components an input converter, an amplifier and an output converter. The input converter is as a rule a sound receiver, e.g. a microphone, and/or an electromagnetic receiver, e.g. an induction coil. The output converter is mostly implemented as an electroacoustic converter, e.g. a miniature loudspeaker, or as an electromechanical converter, e.g. bone conduction earpiece. The amplifier is usually integrated into a signal processing unit. This basic structure is shown in FIG. 1 using a behind-the ear hearing device as an example. One or more microphones 2 for recording the sound from the surroundings are built into a hearing device housing 1 worn behind the ear. A signal processing unit 3, which is also integrated into the hearing device housing 1, processes the microphone signals and amplifies them. The output signal of the signal processing unit 3 is transmitted to a loudspeaker or earpiece 4 which outputs an acoustic signal. The sound is transmitted, if necessary via a sound tube which is fixed with an otoplastic in the auditory canal, to the hearing device wearer's eardrum. Power is supplied to the hearing device and especially to the signal processing unit 3 by a battery 5 also integrated into the hearing device housing 1.

Low-frequency sound which reaches the supplied ear directly is problematic in hearing devices for a number of reasons. By way of example, interfering low-frequency sound occurs in many acoustic situations (car, street, airplane, construction site . . . ), said sound reaching the eardrum through the vent of the hearing device. The term “vent” (ventilation channel) is on the one hand to refer here to the ventilation bore in an in-the-ear hearing device or in the ear mold for a behind-the-ear hearing device. On the other hand, it is to be used for an intended circular opening, which is equivalent to one or a number of actual openings, as occur with devices with an open supply.

Background noise suppressions methods are sufficiently known for hearing devices. In such cases, interference in the microphone signal is generally suppressed and reproduced to a reduced degree. Low-frequency direct sound, which reaches the eardrum through the hearing device, cannot be suppressed in this way. Instead, this is further intensified by the amplified reproduction by the hearing device.

Patent application DE 103 32 119 B3 discloses an active background noise suppression in a hearing aid device which can be worn in the ear or a hearing aid device with an otoplastic which can be worn in the ear. The penetration of direct sound through a ventilation channel of the hearing aid device and/or the otoplastic is prevented by means of a second microphone in the ventilation channel. The second microphone receives an acoustic signal from the ventilation channel and a filter facility moves it in respect of the phase such that the direct sound is largely cancelled after emission of the phase-shifted signal into the ventilation channel.

Patent application U.S. Pat. No. 5,182,774 A also discloses headphones with background noise suppression. A directional microphone records the acoustic pressure within the headphone housing. A generator generates an anti-interference signal from the microphone signal, said anti-interference signal being output via the loudspeaker of the headphones. ANC headphones (Active Noise Cancellation) of this type are nevertheless only based on ANC algorithms, which take the mechanical designs and ways of wearing headphones into account. This is however not easily transferable to hearing devices, which are structured differently in a mechanical sense and are likewise worn differently.

Patent application WO 2005/052911 A1 discloses a hearing apparatus with an otoplastic which can be worn in the ear, including a signal processing facility with an input converter and/or a first microphone, a signal processor and an output converter and/or receiver, with the signal processor being designed to produce a compensation signal, which at least partially attenuates the acoustic signals which enter the auditory canal through ventilation bores of the hearing device. A second microphone is also provided in the auditory canal, from which a signal emanates, which is fed back into the signal processing facility.

The patent application U.S. Pat. No. B1-6,445,799 B1 discloses a noise-suppressing hearing apparatus. In this process, provision is made for an auditory canal tube which can be positioned in the ear, said tube having a microphone for recording the sound in the auditory canal and having a loudspeaker, with the aim being to optionally arrange the microphone and the loudspeaker at the outer end and/or at the inner end of the auditory canal tube which faces the eardrum. The sound signal recorded by the microphone in the auditory canal is fed to a data processing unit, with the noise contained in the sound being filtered out and being fed to the loudspeaker out-of-phase.

### SUMMARY OF INVENTION

Problems with direct sounds also particularly exist if the hearing device is equipped with a wireless receive system, in which the useful signal is injected into the hearing device by radio.

The object of the present invention thus consists in proposing a hearing device, which receives an electrical or electromagnetic useful signal and with which interfering direct sound is better prevented. The aim is also to present a corresponding interference sound suppression method.

In accordance with the invention, this object is achieved by a hearing device having a useful signal interface for recording an electrical or electromagnetic useful signal, a microphone for recording an interference sound outside the ear and a receiver for outputting a processed useful signal, with a vent being formed when the hearing device is being worn in or on the ear, through which vent a sound transmission function exists from the microphone to the eardrum of the hearing device wearer, as well as a filter, which is connected between the microphone and the receiver and the transmission function of which is formed as a function of the sound transmission function of the vent such that an interference sound which reaches the eardrum through the vent is reduced in its effect on the eardrum by means of a balancing sound, which is generated on the basis of a single sound signal, namely an interference sound signal of the microphone from the receiver which results from the interference sound.

Provision is also made in accordance with the invention for a method for reducing an interference sound when a hearing device is being worn by recording an electrical or electromagnetic useful signal by means of the hearing device, recording an interference sound outside the ear by means of a microphone of the hearing device and outputting a processed useful signal from a receiver of the hearing device, with a vent being formed when the hearing device is worn in or on the ear, through which vent a sound transmission function exists from the microphone to the eardrum of the hearing device, as well as by filtering the interference sound signal of the microphone as a function of the sound transmission function of the vent, such that an interference sound which reaches the eardrum through the vent is reduced in its effect on the eardrum by means of a balancing sound, which is generated on the basis of a single sound signal, namely an interference sound signal of the microphone from the receiver which results from the interference sound.

The hearing device and method according to the invention advantageously allow a significant reduction in low-frequency direct sound to be achieved when hearing devices are being worn. The extent of the reduction depends on the parameters of the respective hearing device, e.g. vent diameter, hearing device type etc. A further advantage of the proposed solution consists in the fact that no additional hardware components are needed on the hearing device, since the external microphone which is already present on a hearing device is used to record the interference sound. In addition, the signal processing outlay is very minimal in relation to the operating time of the hearing device, since the filter (digital filter) is predetermined on the basis of the parameters of the hearing device configuration.

The improved hearing device according to the invention can be designed for open supply. This is particularly the case with a high tone supply. The direct sound can reach the eardrum practically unobstructed, said direct sound is however effectively suppressed by means of the balancing sound as far as is necessary in accordance with the invention.

In other cases, a hearing device can comprise an otoplastic, which exhibits a vent for ventilation purposes. The direct sound penetrating through the vent can also be effectively reduced in accordance with the invention.

The transmission function of the above-mentioned filter can comprise a vent diameter as the variable parameter. With an open supply, this vent diameter can be an equivalent diameter. This parameter allows an effective background noise suppression to be set relatively easily for the individual case.

A level limiting circuit is preferably connected between the filter and the receiver. This prevents overmodulation taking place in the event of high signal levels.

### BRIEF DESCRIPTION OF THE DRAWINGS

The present invention is described in more detail with reference to the appended drawings, in which;

FIG. 1 shows the main design of a hearing device in accordance with the prior art;

FIG. 2 shows a block diagram of an inventive hearing device in accordance with a first embodiment;

FIG. 3 shows a block diagram of an inventive hearing device in accordance with a second embodiment and

FIG. 4 shows a diagram for predetermining a digital filter.

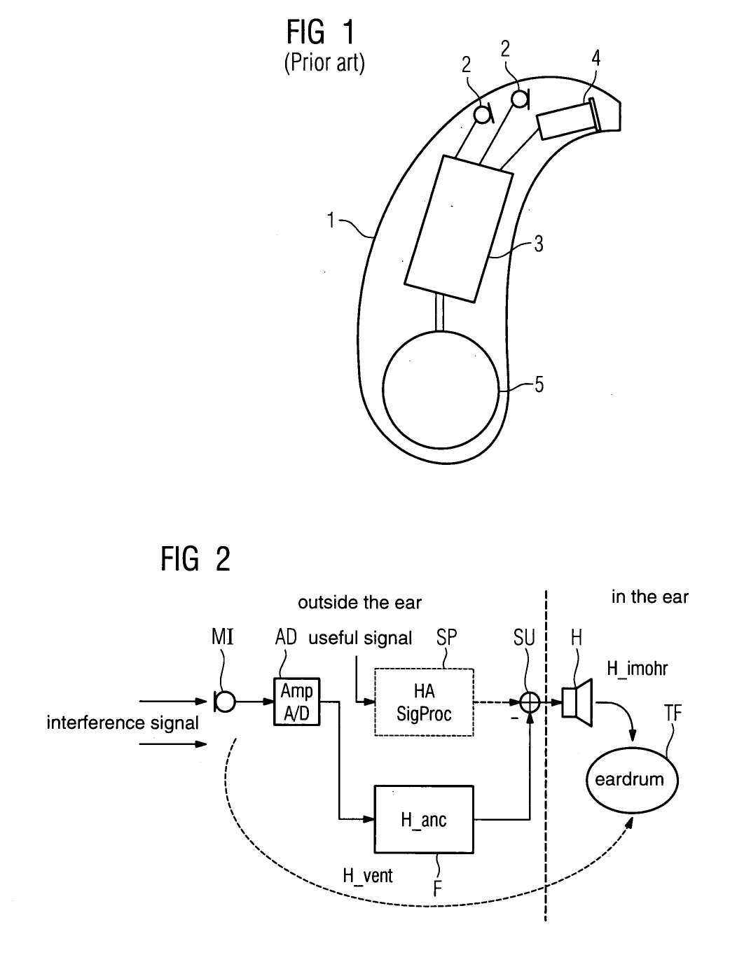

### DETAILED DESCRIPTION OF INVENTION

The embodiments illustrated in more detail below represent preferred exemplary embodiments of the present invention.

The direct sound reaching an eardrum of a hearing device wearer is reduced by means of out-of-phase cancellation. The hearing device receives an electrical or electromagnetic signal as a useful signal in a wireless or wired manner. A hearing device signal processor SP processes the useful signal and supplies an output signal to a receiver H. In the present embodiment, the receiver H is arranged in the ear and/or in the auditory canal, while the remaining part of the hearing device is located outside the ear. The processed useful signal is converted in the receiver H into a useful sound and is acoustically transmitted to the eardrum TF of the hearing device wearer within the auditory canal.

The interference signal and/or ambient signal is recorded with the hearing device microphone MI and the resulting interference sound signal is amplified and digitalized in an amplifier and A/D converter AD. The digital interference signal is subjected to filtering with the transmission function H_anc in a filter for active interference suppression. After filtering, the signal is subtracted from the processed useful signal of the signal processor SP in a subtractor SU, i.e. is added out-of-phase, and is also reproduced in this form via the receiver H.

The hearing device shell or the otoplastic of the hearing device exhibits a vent for ventilation or open supply is directly present. The interference sound can thus also reach the eardrum TF directly through the vent and/or the opening into the ear. A transmission function H-vent results for the direct sound through the vent, which leads to low frequency sound predominantly reaching the eardrum TF by way of this direct path.

The transmission function H_anc is set in the filter F such that the reproduced signal is canceled out-of-phase with the signal which has reached the eardrum TF through the (equivalent) vent on the acoustic path. To this end, the digital filter F is determined such that

H_vent=H_anc×H_imohr

applies to the transmission functions.

In this case, an acoustoelectric conversion in the microphone MI, processing in the amplifier and converter AD as well as a model of the vent are considered in the transmission function H_anc. The transmission function H_imohr represents the electroacoustic transmission of the electrical signal from the loudspeaker to the acoustic signal at the eardrum TF.

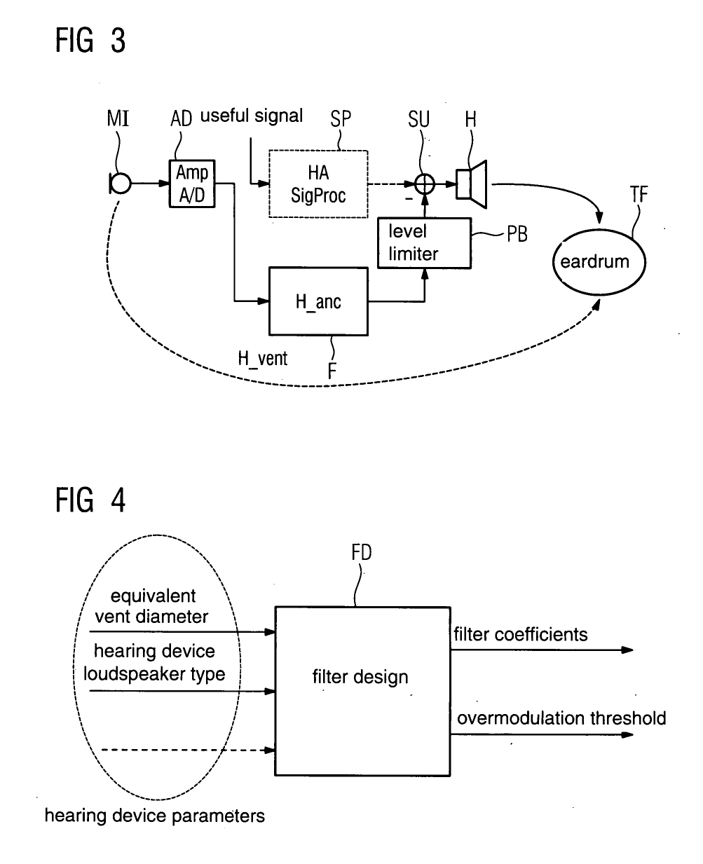

In the case of a particularly open hearing device adjustment, the risk of overmodulation exists in the event of high signal levels. The level, from which overmodulation takes place, is determined by the hearing device loudspeaker type in addition to the equivalent vent diameter. In order to prevent overmodulation, a hearing device according to FIG. 3 is provided in accordance with a second embodiment of the present invention. This essentially corresponds to that of FIG. 2. To protect against overmodulation however, a level limiter PB is inserted into the interference signal path. The signal level is thus limited after the ANC filtering through the filter F, before the signal is supplied to the subtractor SU.

The digital ANC filter F must be designed taking into account basic hearing device conditions, since these determine the (electro-) acoustic transmission functions H_vent and H_imohr. This hearing device-specific design of the ANC filter F is expediently designed beforehand in respect of parameters, e.g. during hearing device adjustment. Only known parameters such as (equivalent) vent diameter and vent length as well as hearing device loudspeaker type are used as input variables in accordance with FIG. 4. A dashed arrow in FIG. 4 indicates that other specific parameters can also be used as input variables. The analog transmission function H_vent can be determined from these input variables. Hence, the digital filter F can in turn be found by means of standard methods for signal processing. This is characterized by the corresponding filter coefficients.

The hearing device system-specific parameters are similarly used here to determine a threshold, from which overmodulation of the loudspeaker H is to be expected. Accordingly, an overmodulation threshold is also obtained from the input variables according to FIG. 4 with the filter design FD. This overmodulation threshold is then used in the level limiter PB (cf. FIG. 3) to limit the filter output signal.

Particular advantages of the illustrated exemplary embodiments result if the useful signal is injected into the hearing device by radio. With this application the ambient noise is predominantly interfering. Each acoustic signal is thus interfering for instance if a telephone signal is transmitted inductively to the hearing device. Acoustically received noises are likewise interfering if a piece of music is transmitted to the hearing device by way of a radio interface. Out-of-phase cancellation taking into account the vent transmission function nevertheless allows interferences of this type to be eliminated. In this sense, the hearing device and/or the method according to the invention can also be advantageously used for active ear plugs and for instance with reproduction for music transmitted in a wired fashion (e.g. via an audio shoe).

1.-9. (canceled)

10. A hearing device, comprising:
a useful signal interface for recording an electrical or electromagnetic useful signal;
a microphone for recording an interference sound outside the ear;
a receiver for outputting a processed useful signal;
a vent being formed when the hearing device is worn in or on the ear, through which vent a sound transmission function from the microphone to the eardrum of the hearing device wearer exists; and
a filter, connected between the microphone and the receiver and the transmission function of which is formed as a function of the sound transmission function of the vent such that an interference sound reaching the eardrum through the vent is reduced in its effect on the eardrum by a balancing sound, which is generated on the basis of a single interference signal, namely an interference sound signal of the microphone from the receiver which results from the interference sound.

11. The hearing device as claimed in claim 10, wherein the hearing device is designed for open supply.

12. The hearing device as claimed in claim 10, further comprises an otoplastic having a vent.

13. The hearing device as claimed in claim 10, wherein the transmission function comprises a vent diameter as a variable parameter.

14. The hearing device as claimed in claim 13, wherein the vent diameter is an equivalent diameter for an open supply.

15. The hearing device as claimed in claim 10, wherein a level limiting circuit is connected between the filter and the receiver.

16. A method for reducing an interference sound when wearing a hearing device, comprising:
recording an electrical or electromagnetic useful signal via the hearing device;
recording an interference sound outside the ear via a microphone of the hearing device;
outputting a processed useful signal from a receiver of the hearing device;
wherein a vent being formed when the hearing device is being worn in or on the ear, through which vent a sound transmission function from the microphone to the eardrum of the hearing device wearer exists; and
filtering the interference sound signal of the microphone as a function of the sound transmission function of the vent such that an interference sound reaching the eardrum through the vent is reduced in its effect on the eardrum via a balancing sound, which is generated on the basis of an single sound signal, namely an interference sound signal of the microphone from the receiver resulting from the interference sound.

17. The method as claimed in claim 16, wherein the filter transmission function of the filter being adjusted beforehand by inputting a vent diameter accordingly as a parameter.

18. The method as claimed in claim 16, wherein the signal being subjected to a level limitation after the filtering process.
